(19) United States
(12) Patent Application Publication
(10) Pub. No.: US 2026/0200169 A1
(43) Pub. Date: Jul. 16, 2026

(54) VAT PHOTOPOLYMERIZATION AND PICK AND PLACE PRINTER

(71) Applicant: Honeywell Federal Manufacturing & Technologies, LLC, Kansas City, MO (US)

(72) Inventor: Neiko Levenhagen, Kansas City, MO (US)

(21) Appl. No.: 19/449,773

(22) Filed: Jan. 15, 2026

Related U.S. Application Data
(60) Provisional application No. 63/745,470, filed on Jan. 15, 2025.

(51) Int. Cl. B29C 64/245; B29C 64/264; B29C 64/379; B33Y 10/00; B33Y 30/00

(52) U.S. Cl. CPC B29C 64/245; B29C 64/264; B29C 64/379; B33Y 10/00; B33Y 30/00

(57) ABSTRACT

A build stage for additively producing a three-dimensional workpiece is provided. The build stage includes a build plate, an elevator, a gantry, a horizontal actuator, and a pick-and-place robot. The build plate is for supporting the three-dimensional workpiece. The elevator is operable to shift the build plate vertically. The gantry is operable to shiftably support the elevator. The horizontal actuator is configured to shift the elevator horizontally along the gantry in order to be proximal to the pick-and-place robot. The pick-and-place robot is configured to place components onto the three-dimensional workpiece during production.

### CROSS-REFERENCE TO RELATED APPLICATIONS

This non-provisional patent application claims priority benefit of U.S. Provisional Patent Application Ser. No. 63/745,470 entitled “VAT PHOTOPOLYMERIZATION AND PICK AND PLACE PRINTER,” filed Jan. 15, 2025, the entire disclosure of which is incorporated herein by reference.

### FEDERALLY SPONSORED RESEARCH AND DEVELOPMENT

This invention was made with Government support under Contract No.: DE-NA0002839 awarded by the United States Department of Energy/National Nuclear Security Administration. The Government has certain rights in the invention.

### BACKGROUND

Three-dimensional printing, a form of additive manufacturing, builds objects layer by layer from digital models, enabling precise and efficient production of complex geometries. Many types of three-dimensional printing are used in industry, such as material extrusion, powder bed fusion, and vat photopolymerization. Vat photopolymerization is a specific type of additive manufacturing process that involves a liquid resin located in a chamber or vat that is systematically cured on a build platform to form an object. In order to manufacture certain objects, such as objects with components that are made of material different than the resin, components must be attached post processing. However, this additional step in post processing increases labor costs and the window for introducing defects in the build process.

Thus, there is a need for an improved method of three-dimensional printing. This background discussion is intended to provide information related to the present invention which is not necessarily prior art.

### BRIEF SUMMARY

Embodiments of the current invention address one or more of the above-mentioned problems and provide a distinct advance in the art of additively producing a three-dimensional workpiece.

One embodiment of the present invention is a build stage for additively producing a three-dimensional workpiece. The build stage includes a build plate, an elevator, a gantry, one or more horizontal actuators, and a pick-and-place robot. The build plate is for supporting the three-dimensional workpiece. The elevator is operable to shift the build plate vertically. The gantry is operable to shiftably support the elevator. The one or more horizontal actuators are configured to shift the elevator horizontally along the gantry in order to be proximal to the pick-and-place robot. The pick-and-place robot is configured to add one or more components to the three-dimensional workpiece.

Another embodiment of the invention is a method of forming a three-dimensional workpiece. The method includes forming, via one or more radiation sources, one or more first layers of the three-dimensional workpiece on a build plate positioned in a vat; shifting, via an elevator, the build plate with the one or more first layers vertically out of the vat; shifting, via one or more horizontal actuators, the build plate horizontally to a second position within the work area of a pick-and-place robot; positioning, via the pick-and-place robot, one or more components of the three-dimensional workpiece in operative association with the one or more first layers; shifting, via the one or more horizontal actuators, the build plate horizontally to a first position above the vat; shifting, via the elevator, the build plate with the one or more first layers and the one or more components vertically into the vat; and forming, via the one or more radiation sources, one or more additional layers of the three-dimensional workpiece on the build plate.

Another embodiment of the invention is a system for additively producing a three-dimensional workpiece. The system includes a build plate, a vat, one or more radiation sources, an elevator, a pick-and-place robot, a gantry, and one or more horizontal actuators. The build plate is for supporting the three-dimensional workpiece. The vat is for containing liquid and receiving the build plate. The one or more radiation sources are for selectively curing the liquid in the vat on the build plate. The elevator is operable to shift the build plate vertically relative to the vat. The pick-and-place robot is positioned adjacent to the vat. The gantry is operable to shiftably support the elevator. The one or more horizontal actuators are configured to shift the elevator horizontally between a first position in which the build plate can be lowered into the vat of of liquid and a second position proximal to the pick-and-place robot.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE SEVERAL VIEWS OF THE DRAWINGS

To easily identify the discussion of any particular element or act, the most significant digit or digits in a reference number refer to the figure number with which that element is first introduced in said discussion.

Embodiments of the current invention are described in detail below with reference to the attached drawing figures, wherein:

FIG. 1 is a perspective view of a build stage constructed according to an embodiment of the present invention for additively manufacturing a three-dimensional workpiece with a build plate in a first position in an additive manufacturing region above a vat of feedstock;

FIG. 2 is a perspective view of the build stage of FIG. 1 with the build plate in the additive manufacturing region but lowered into the vat of feedstock for photopolymerization of the three-dimensional workpiece;

FIG. 3 is a perspective view of the build stage of FIG. 1 with the build plate returned to the first position in the additive manufacturing region above the vat of feedstock with one or more first layers formed on the build plate;

FIG. 4 is a perspective view of the build stage of FIG. 1 with the build plate positioned at a second position in a pick-and-place region in order to be in a work area of a pick-and-place robot so that one or more components may be added to the one or more first layers;

FIG. 5 is a perspective view of the build stage of FIG. 1 with the build plate returned to the first position in the additive manufacturing region after the photopolymerization of one or more additional layers;

FIG. 6 is a block diagram depicting selected components of a control system operable to control components of the build stage of FIG. 1; and

FIG. 7 is a flowchart depicting exemplary steps of a method according to one or more embodiments of the present invention.

### DETAILED DESCRIPTION

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

In certain applications one or more elements must be custom made. One solution for forming customized components is via additive manufacturing, such as material extrusion (e.g., FDM, FFF), vat photopolymerization (e.g., SLA, DLP), material jetting (e.g., MJP), powder bed fusion (e.g., SLS, SLM), binder jetting, directed energy deposition (e.g., LENS, EBAM), and sheet lamination (e.g., LOM, UAM). These methods are particularly useful when forming electrical connector housings. However, one downside to using additive manufacturing to form connector housings is that pins still have to be hand placed and subsequently fixed in place by an epoxy, another adhesive, or an attachment mechanism (e.g., screws or tabs). Embodiments of the present invention enable simultaneous printing via additive manufacturing and the placement of electrical components. This enables an automated method for the complete printing of functional connectors and other electrical or electronic components that are often made by overmolding. This further eliminates the need for glues, epoxies, adhesives, or other attachment mechanisms to hold the pins or electrical components in place. Embodiments of the invention have been found to be especially useful due to long lead times for commercial off the shelf connectors.

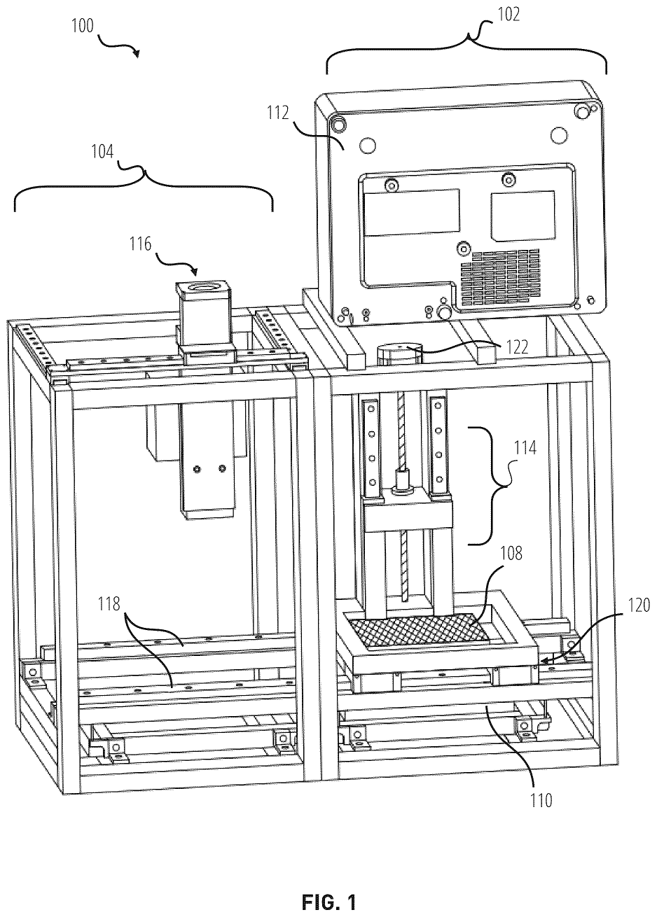

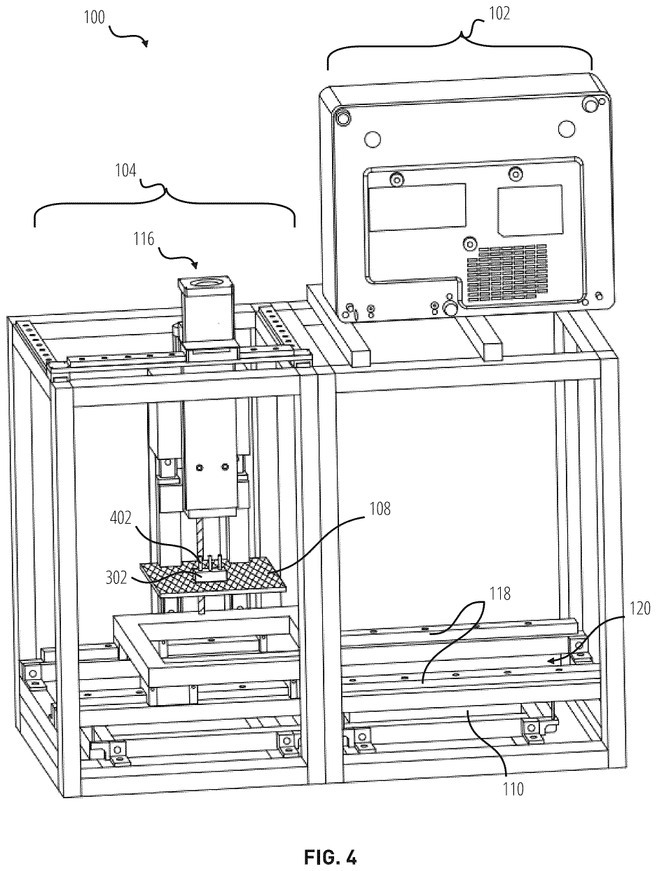

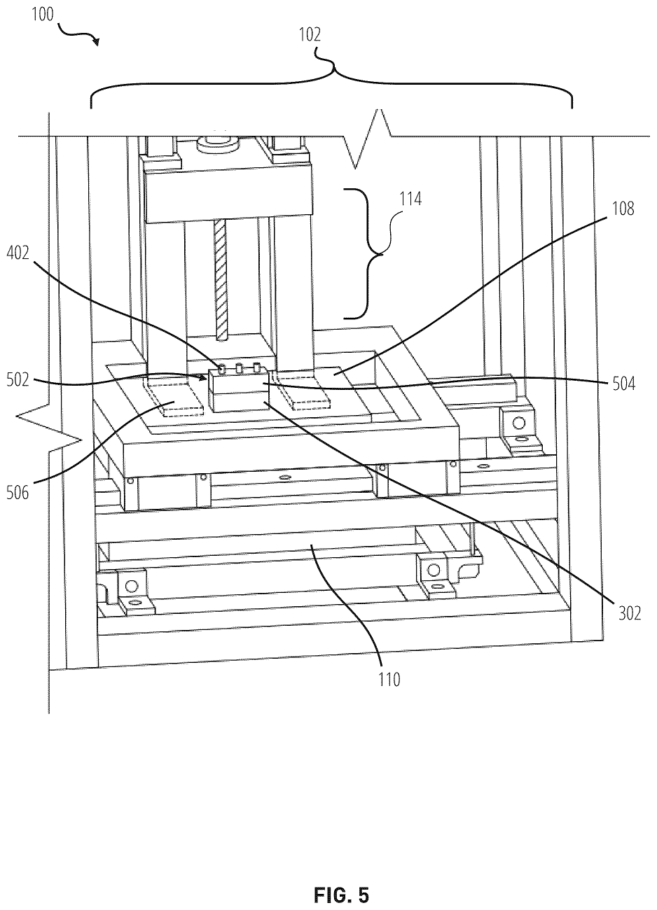

Turning to FIG. 1, a build stage 100 constructed according to an embodiment of the present invention is depicted. The build stage 100 is configured to form one or more three-dimensional workpieces 502 (depicted in FIG. 5) made from disparate materials, such as an electrical connector, harness, or the like. The disparate materials may include a feedstock such as a liquid (e.g., a photo resin), a plastic (e.g., polylactic acid, polyethylene terephthalate glycol, acrylonitrile butadiene styrene), a powder (e.g., nylon, thermoplastic polyurethane), metals (e.g., stainless steel, aluminum), ceramics (e.g., alumina), and/or any substrate that is known in the art and used for additive manufacturing, as well as one or more components 402 (depicted in FIG. 4 and FIG. 5), such as metal pins, electrical components, threaded inserts, and/or other elements that are known in the art to modify workpieces of additive manufacturing origin. In the accompanying figures the feedstock is a liquid photo resin and is inside of a vat 110 in the additive manufacturing region 102, but the feedstock is not limited to such an embodiment. In one or more embodiments the build stage 100 does not utilize subtractive manufacturing techniques.

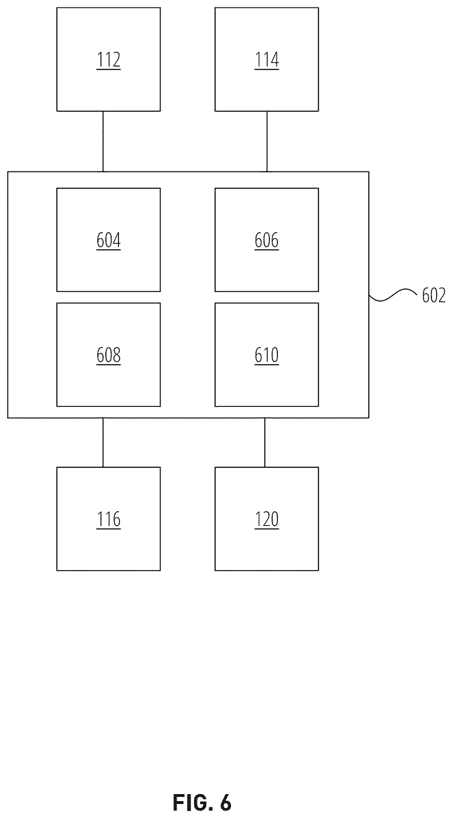

The build stage 100 defines an additive manufacturing region 102 and a pick-and-place region 104 and broadly comprises a build plate 108, a vat 110, one or more radiation sources 112, an elevator 114, a pick-and-place robot 116, a gantry 118, one or more horizontal actuators 120 (represented in FIG. 6), one of one or more vertical actuators 122, and a control system 602 (depicted in FIG. 6). In one or more embodiments, the parts of the build stage 100 may be assembled into a single machine as depicted or the parts of the build stage 100 may be integrated into a manufacturing system or process.

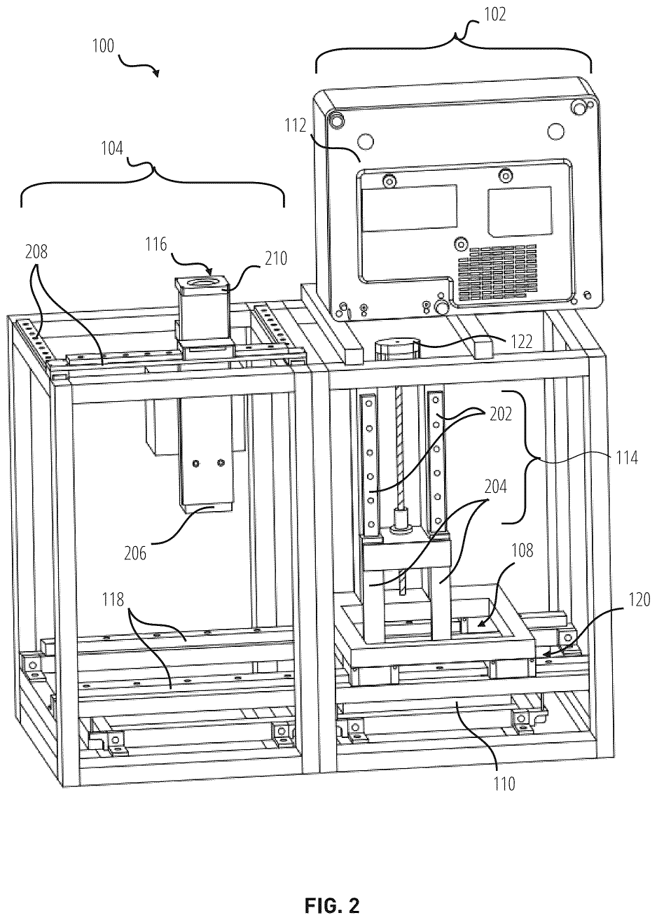

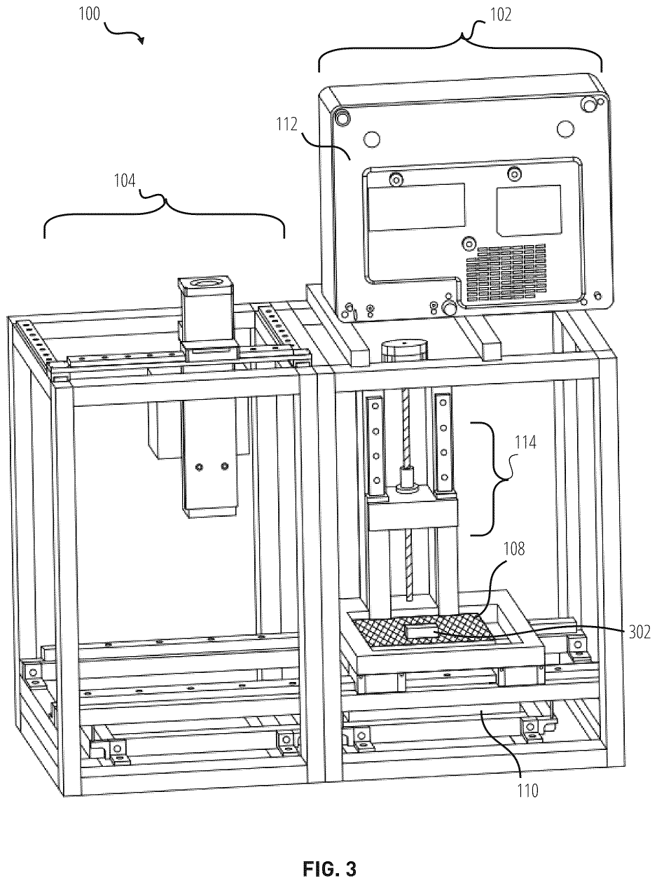

Turning to FIG. 2, the build plate 108 is for supporting the three-dimensional workpiece and is sized to fit inside a top opening of the vat 110. The vat 110 is operable to receive the build plate 108 and contain the feedstock for forming the three-dimensional workpiece 502. In one or more embodiments, the one or more radiation sources 112 are configured to selectively cure the feedstock in the vat 110 on the build plate 108 to form one or more layers 302 (depicted in FIG. 3) of the three-dimensional workpiece 502. In one or more embodiments, the one or more radiation sources 112 is positioned above the vat 110 and comprises an ultraviolet light source with sufficient power to cure the feedstock in the form of a photo resin. However, the one or more radiation sources 112 may be any type of radiation source used in additive manufacturing known in the art without departing from the scope of the present invention.

The elevator 114 is operable to shift the build plate 108 vertically relative to the vat 110. The elevator 114 is configured to insert the build plate 108 into the feedstock in the vat 110 for building the workpiece and shift the build plate 108 upwards to remove it from the feedstock. In one or more embodiments, the elevator 114 comprises a pair of one or more vertically extending tracks 202, one or more carriages 204, one or more vertical actuators 122, and one or more arms 506 (depicted in FIG. 5) operatively associated with the build plate 108. As used herein, “actuator” includes any kind of actuator known in the art, including motors, servos, stepper motors, linear actuators, hydraulic actuators, pneumatic actuators, or the like. Any actuator described herein may drive the moveable component directly or may employ any form of mechanical transmission system known in the art to transfer motion (e.g., belts, chains, pulleys, gears, or the like). In one or more embodiments, the arms 506 are spaced apart from the carriages 204 to allow for the arms to extend into the vat 110 with the build plate 108.

In one or more embodiments, the pick-and-place robot 116 is positioned within the pick-and-place region 104 adjacent to the additive manufacturing region 102. As used herein, a “pick-and-place robot” may comprise any programmable system to control motion, manage object detection and orientation, actuate gripping mechanisms, communicate with other devices, execute task sequencing, and/or generally move, detect, grip, and place objects accurately within an automated process without departing from the scope of the invention. For example, the pick-and-place robot 116 may comprise a cartesian robot, a selective compliance assembly robot arm (SCARA) robot, an articulated arm robot, a delta robot, or the like. In one or more embodiments, the pick-and-place robot 116 includes an end effector 206 for engaging and disengaging one or more components 402 (depicted in FIG. 4) of the three-dimensional workpiece 502, a robot gantry 208 for shifting the end effector 206 in the x-direction and/or the y-direction (directions parallel with a top surface of the build plate 108), and one or more robot actuators 210 operable to cause the end effector 206 to shift and to complete processes relating to placing the one or more components 402. In one or more embodiments, the one or more robot actuators 210 are also configured to shift the end effector 206 in the z-direction (direction perpendicular to the top surface of the build plate 108). In the accompanying figures the pick-and-place robot 116 is depicted as a cartesian robot, however, the pick-and-place robot 116 may be any type of pick-and-place robot 116 known in the art without departing from the scope of the invention.

The gantry 118 is operable to shiftably support the elevator 114. The gantry 118 allows the elevator 114, and therefore the build plate 108, to shift between the additive manufacturing region 102 and the pick-and-place region 104. In one or more embodiments, the gantry 118 allows the elevator 114, and therefore the build plate 108, to shift horizontally. The one or more horizontal actuators 120 are configured to shift the elevator 114 along the gantry 118. In one or more embodiments, the one or more horizontal actuators 120 are configured to shift the elevator 114 horizontally between a first position within the additive manufacturing region 102 in which the build plate 108 can be lowered into the vat 110 and a second position (as depicted in FIG. 4) within the pick-and-place region 104 in which the build plate 108 is proximal to the pick-and-place robot 116. However, the build plate 108 and the pick-and-place robot 116 may be shifted relative to one another any number of ways without departing from the scope of the present invention.

Turning to FIG. 6, the control system 602 is configured to control operations of the build stage 100. The control system 602 may comprise one or more communication elements 604, one or more memory elements 606, a user interface 608, and one or more processing elements 610. In one or more embodiments, the one or more memory elements 606 has stored thereon computer-aided drawings, instructions, code, or plans for the workpiece, including set points in which the build plate 108 is to exit the vat 110 and locations for placing the one or more components 402. The control system 602 may be in communication with one or more elements of the build stage 100, including the one or more radiation sources 112, the elevator 114, the pick-and-place robot 116, the one or more horizontal actuators 120, and the one or more vertical actuators 122.

In use, the control system 602 may be configured to direct the one or more radiation sources 112 to form one or more layers 302 of the three-dimensional workpiece 502 by curing the feedstock 106 in the vat 110 on the build plate 108 (as depicted in FIG. 2). The control system 602 may then direct the one or more vertical actuators 122 to lift the build plate 108 out of the vat 110 (as depicted in FIG. 3).

As depicted in FIG. 4, the control system 602 may be configured to direct the one or more horizontal actuators 120 to shift the build plate 108 into the pick-and-place region 104 to a second position beneath the pick-and-place robot 116 along the gantry 118 via the one or more horizontal actuators 120. The control system 602 may be configured to direct the pick-and-place robot 116 to place one or more components 402 on the one or more layers 302 of the three-dimensional workpiece 502. In one or more embodiments the one or more components 402 are not pretreated before being placed on the one or more one or more layers 302 of the three-dimensional workpiece 502. The one or more components 402 may be held in place on the one or more layers 302 via guides, slots, clips, or the like in accordance with common practices known in the art of the overmolding manufacturing of similar three-dimensional objects. In one or more embodiments the one or more components 402 are not circuit elements, and/or circuits on dielectric substrates, and/or microchips.

As depicted in FIG. 5, the control system 602 may be configured to direct the elevator 114, and therefore the build plate 108, to be shifted back to the additive manufacturing region 102 to the first position above the vat 110. The control system 602 may be configured to direct the build plate 108 to be inserted into the feedstock 106 in the vat 110, similar to FIG. 2. The control system 602 may be configured to then direct the one or more radiation sources 112 to cure one or more additional layers 504 of the feedstock onto the one or more layers 302 thereby capturing the one or more layers 302 of the three-dimensional workpiece 502. The control system 602 may be configured to repeat one or more of these processes any number of times and in any order to complete the three-dimensional workpiece 502.

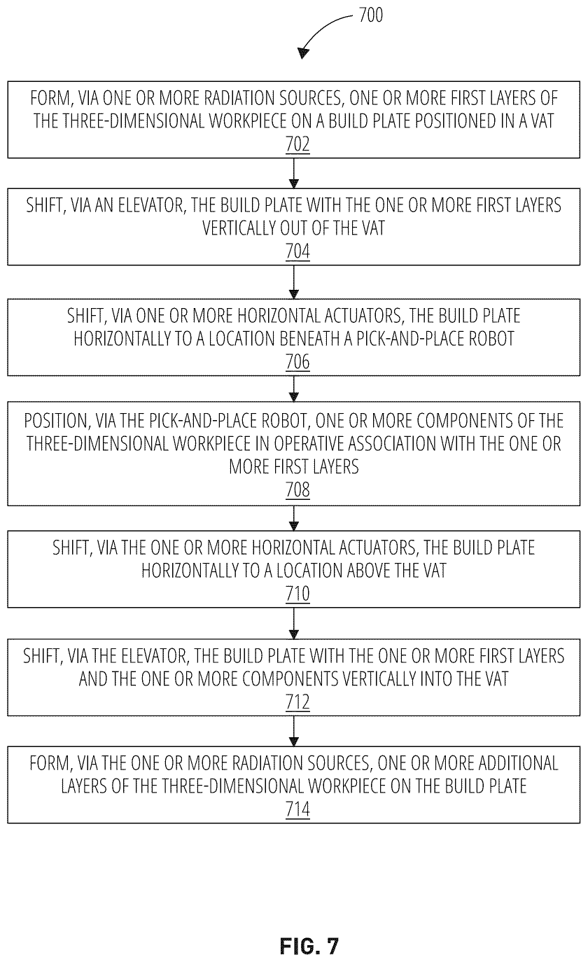

The flow chart of FIG. 7 depicts the steps of an exemplary method 700 of forming a three-dimensional workpiece 502. In some alternative implementations, the functions noted in the various blocks may occur out of the order depicted in FIG. 7. For example, two blocks shown in succession in FIG. 7 may in fact be executed substantially concurrently, or the blocks may sometimes be executed in the reverse order depending upon the functionality involved. In addition, some steps may be optional.

The method 700 is described below, for ease of reference, as being executed by exemplary devices and components introduced with the embodiments illustrated in FIGS. 1-6. The steps of method 700 may be performed by the control system 602 through the utilization of processors, transceivers, hardware, software, firmware, or combinations thereof. However, some of such actions may be distributed differently among such devices or other devices without departing from the spirit of the present invention. Control of the build stage 100 may also be partially implemented with computer programs stored on one or more non-transient computer readable medium(s). The computer-readable medium(s) may include one or more executable programs stored thereon, wherein the program(s) instruct one or more processing elements 610 to perform all or certain of the steps outlined herein. The program(s) stored on the computer-readable medium(s) may instruct processing element(s) to perform additional, fewer, or alternative actions, including those discussed elsewhere herein.

Referring to step 702, one or more layers 302 of the three-dimensional workpiece 502 are formed, via the one or more radiation sources 112, on the build plate 108 positioned in the vat 110 containing the feedstock within the additive manufacturing region 102. The elevator 114 and the build plate 108 may be positioned over the vat 110 along the gantry 118 via the one or more horizontal actuators 120. Then the one or more vertical actuators 122 of the elevator 114 may lower the build plate 108 into the vat 110, and the one or more radiation sources 112 may emit radiation toward the build plate 108 to cure the one or more layers 302 on the build plate 108.

Referring to step 704, the build plate 108 along with the one or more layers 302 is shifted, via the elevator 114, vertically out of the vat 110. This step may include actuating via the one or more vertical actuators 122 of the elevator 114 to translate the one or more carriages 204 and therefore the one or more arms 506 and the build plate 108 up the one or more vertically extending tracks 202. The build plate 108 may be raised to sufficient height so that it is completely lifted out of the vat 110 and can freely shift horizontally.

Referring to step 706, the build plate 108 is horizontally shifted, via the one or more horizontal actuators 120, into the pick-and-place region 104 to a second position within the work area of the pick-and-place robot 116. The work area of the pick-and-place robot 116 is the volume of space in which the pick-and-place robot 116 may perform necessary functions as described. In one or more embodiments, the elevator 114 along with the build plate 108 are shifted along the gantry 118 from a first position above the vat 110 to a second position beneath the pick-and-place robot and/or within the pick-and-place region 104.

Referring to step 708, one or more components 402 of the three-dimensional workpiece 502 are positioned, via the pick-and-place robot, in operative association with the one or more layers 302. The pick-and-place robot 116 and/or the build plate 108 may be adjusted by their respective actuators (120, 122, 210) so that the one or more components 402 are placed in the desired location relative to the one or more layers 302.

Referring to step 710, the build plate 108 is horizontally shifted, via the one or more horizontal actuators 120, back into the additive manufacturing region 102 to the first position above the vat 110. This step may include actuating the one or more vertical actuators 122 of the elevator 114 and/or the one or more horizontal actuators 120 along the gantry 118 back to the first position above the vat 110 and below the one or more radiation sources 112.

Referring to step 712, the build plate 108 along with the one or more layers 302 and the one or more components 402 are shifted, via the elevator 114, vertically into the vat 110. The one or more layers 302 may be submerged in the feedstock 106 contained in the vat 110.

Referring to step 714, one or more additional layers 504 of the three-dimensional workpiece 502 are formed, via the one or more radiation sources 112, on the build plate 108. The one or more additional layers 504 may be formed on top of the one or more layers 302 and the one or more components 402. Steps 702 through 714 may be repeated any number of times for any number of layers until the three-dimensional workpiece 502 is completed.

The method 700 may include additional, less, or alternative steps and/or device(s), including those discussed elsewhere herein.

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain 9 of 16 manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general purpose processor may be configured as respective different processing elements at different times. Software may accordingly configure the processing element to constitute a particular hardware configuration at one instance of time and to constitute a different hardware configuration at a different instance of time.

The processing element may include processors, microprocessors (single-core and multi-core), microcontrollers, DSPs, field-programmable gate arrays (FPGAs), analog and/or digital application-specific integrated circuits (ASICs), or the like, or combinations thereof. The processing element may generally execute, process, or run instructions, code, code segments, software, firmware, programs, applications, apps, processes, services, daemons, or the like. The processing element may also include hardware components such as finite-state machines, sequential and combinational logic, and other electronic circuits that can perform the functions necessary for the operation of the current invention. The processing element may be in communication with the other electronic components through serial or parallel links that include address busses, data busses, control lines, and the like.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process 10 of 16 the stored output. Computer hardware components may also initiate communications with input or output devices, and may operate on a resource (e.g., a collection of information).

The memory device or element may include data storage components, such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, or the like, or combinations thereof. In some embodiments, the memory element may be embedded in, or packaged in the same package as, the processing element. The memory element may include, or may constitute, a “computer-readable medium”. The memory element may store the instructions, code, code segments, software, firmware, programs, applications, apps, services, daemons, or the like that are executed by the processing element.

The communication element may generally allow communication with systems and/or external devices. The communication element may include signal or data transmitting and receiving circuits, such as antennas, amplifiers, filters, mixers, oscillators, digital signal processors (DSPs), and the like. The communication element may establish communication wirelessly by utilizing RF signals and/or data that comply with communication standards such as cellular 2G, 3G, 4G, 5G, or LTE, WiFi, WiMAX, Bluetooth®, BLE, or combinations thereof. The communication element may be in communication with the processing element and the memory element

The user interface generally allows the user to utilize inputs and outputs to interact with the device and is in communication with the one or more processing element. Inputs may include buttons, pushbuttons, knobs, jog dials, shuttle dials, directional pads, multidirectional buttons, switches, keypads, keyboards, mice, joysticks, microphones, or the like, or combinations thereof. The outputs of the present invention may include a display and/or any number of additional outputs, such as audio speakers, lights, dials, meters, printers, or the like, or combinations thereof, without departing from the scope of the present invention.

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 108(f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

What is claimed is:

1. A build stage for additively producing a three-dimensional workpiece, the build stage comprising:
a build plate for supporting the three-dimensional workpiece;
an elevator operable to shift the build plate vertically;
a gantry operable to shiftably support the elevator;
one or more horizontal actuators configured to shift the elevator horizontally along the gantry; and
a pick-and-place robot configured to add one or more components to the three-dimensional workpiece,
wherein the one or more horizontal actuators are configured to shift the build plate proximal to the pick-and-place robot.

2. The build stage of claim 1, wherein the elevator comprises one or more vertically extending tracks.

3. The build stage of claim 1, wherein the elevator comprises one or more vertical actuators.

4. The build stage of claim 2, wherein the one or more vertically extending tracks includes two or more tracks, and the elevator comprises:
two or more carriages shiftably attached to the two or more tracks; and
two or more arms operatively associated with the build plate and the two or more carriages.

5. The build stage of claim 4, wherein the two or more arms are spaced apart from the two or more carriages.

6. The build stage of claim 5, wherein the one or more vertical actuators of the elevator are operable to shift the build plate into a vat for photopolymerization of the three-dimensional workpiece.

7. The build stage of claim 1, wherein the one or more horizontal actuators are configured to shift the build plate under an end effector of the pick-and-place robot.

8. A method of forming a three-dimensional workpiece, the method comprising:
forming, via one or more radiation sources, one or more first layers of the three-dimensional workpiece on a build plate positioned in a vat;
shifting, via an elevator, the build plate with the one or more first layers vertically out of the vat;
shifting, via one or more horizontal actuators, the build plate horizontally to a second position within a work area of a pick-and-place robot;
positioning, via the pick-and-place robot, one or more components of the three-dimensional workpiece in operative association with the one or more first layers;
shifting, via the one or more horizontal actuators, the build plate horizontally to a first position above the vat;
shifting, via the elevator, the build plate with the one or more first layers and the one or more components vertically into the vat; and
forming, via the one or more radiation sources, one or more additional layers of the three-dimensional workpiece on the build plate.

9. The method of claim 8, wherein the elevator comprises one or more vertically extending tracks and one or more vertical actuators.

10. The method of claim 9, wherein the one or more vertically extending tracks includes two or more tracks, and the elevator comprises:
two or more carriages shiftably attached to the two or more tracks; and
two or more arms operatively associated with the build plate and the two or more carriages.

11. The method of claim 10, wherein the two or more arms are spaced apart from the two or more carriages.

12. The method of claim 8, wherein the elevator is operable to shift the build plate into the vat for photopolymerization of the three-dimensional workpiece.

13. The method of claim 8, wherein the one or more horizontal actuators are configured to shift the elevator supporting the build plate along a gantry.

14. The method of claim 8, wherein the three-dimensional workpiece is an electrical connector, and the one or more components are one or more metal connector pins.

15. A system for additively producing a three-dimensional workpiece, the system comprising:
a build plate for supporting the three-dimensional workpiece;
a vat for receiving the build plate and containing liquid;
one or more radiation sources for selectively curing the liquid in the vat on the build plate;
an elevator operable to shift the build plate vertically relative to the vat;
a pick-and-place robot positioned adjacent to the vat;
a gantry operable to shiftably support the elevator; and
one or more horizontal actuators configured to shift the elevator horizontally between a first position in which the build plate can be lowered into the vat and a second position proximal to the pick-and-place robot.

16. The method of claim 15, wherein the elevator comprises one or more vertically extending tracks and one or more vertical actuators.

17. The method of claim 16, wherein the one or more vertically extending tracks includes two or more tracks, and the elevator comprises:
two or more carriages shiftably attached to the two or more tracks; and
two or more arms operatively associated with the build plate and the two or more carriages.

18. The method of claim 17, wherein the two or more arms are spaced apart from the two or more carriages.

19. The method of claim 15, wherein the one or more vertical actuators of the elevator are operable to shift the build plate into the vat for photopolymerization of the three-dimensional workpiece, and the three-dimensional workpiece is an electrical connector with one or more metal connector pins.

20. The method of claim 15, wherein the one or more horizontal actuators are configured to shift the build plate beneath an end effector of the pick-and-place robot.
